(19) United States
(12) Patent Application Publication
(10) Pub. No.: US 2018/0330021 A1
(43) Pub. Date: Nov. 15, 2018

(54) METHOD AND COMPUTER SYSTEM FOR PLANNING A PLANT IN THE FIELD OF THE BEVERAGE PROCESSING INDUSTRY

(71) Applicant: KRONES AG, Neutraubling (DE)

(72) Inventors: Martin SEGER, Neumarkt. i. d. Opf (DE); Michael JOGSCH, Barbing (DE)

(21) Appl. No.: 15/975,299

(22) Filed: May 9, 2018

(30) Foreign Application Priority Data
May 10, 2017 (DE) 10 2017 207 894.4

(51) Int. Cl. G06F 17/50; G06T 17/10

(52) U.S. Cl. CPC G06F 17/5004; G06T 2210/04; G06T 17/10; G06F 17/5086

(57) ABSTRACT

Method for planning a plant in the field of the beverage processing industry with at least one machine component, wherein the at least one machine component is configured based on task specifications, wherein the at least one configured machine component, at least one associated virtual 3D-machine measurement sheet is generated, real surroundings for the installation of the at least one machine component are captured with a camera system, and the at least one virtual 3D-machine measurement sheet is virtually arranged in the captured real surroundings.

### CROSS-REFERENCE TO RELATED APPLICATION

This application claims priority to German Patent Application No. 10 2017 207 894.4 entitled “METHOD AND COMPUTER SYSTEM FOR PLANNING A PLANT IN THE FIELD OF THE BEVERAGE PROCESSING INDUSTRY,” filed on May 10, 2017, the entire content of which is incorporated here in reference in its entirety for all purposes.

### BACKGROUND AND SUMMARY

The present disclosure relates to a method for planning a plant in the field of the beverage processing industry with at least one machine, and a computer system that may include a stationary computer and a mobile computer for planning a plant in the field of the beverage processing industry.

When planning a plant in the field of the beverage processing industry, it is usually clarified during the offer process which tasks the machine components have to perform. Based on this information, task specifications are then generated to configure the machine components with the task specifications. For example, in case of a filler, the task specifications determine which container types are envisaged for being processed with the plant and which products are to be filled into the containers. In case of a labeling machine, the task specifications determine, for example, which type of labels are to be attached to the containers. Subsequently, for each machine component, an associated 2D-machine measurement sheet is generated and then inserted into a layout of the plant at a corresponding point. Using this, one can show the customer how the machine components must be positioned with respect to each other and what will consequently be the size of the plant.

It is here a disadvantage that the planning process is time consuming since any changes, for example, have to pass through all planning stations again. Moreover, this involves risks since the situation at the plant operator's site and the machine components provided there are not completely included in the layout.

It is therefore the object of the present disclosure to provide a method and a computer system for planning a plant in the field of the beverage processing industry permitting a quicker and safer planning process.

To achieve this object, the present disclosure provides a method for planning a plant in the field of the beverage processing industry

By generating the at least one associated virtual 3D-machine measurement sheet from the at least one configured machine component, the extent of the respective machine component can be considered not only as a 2D-projection, but as a 3D-body. Consequently, different cross-sections of the at least one machine component in different heights may be thereby considered during planning. By capturing the real surroundings for the installation of the at least one machine component with the camera system, the actual premises for the plant are captured, instead of a possibly only incomplete or faulty plan. Therefore, differences between the actual premises and the planning are avoided. Since the at least one virtual 3D-machine measurement sheet is virtually arranged in the captured real surroundings, an operator may particularly reliably and quickly see whether the at least one machine component may be erected unobstructedly. For example, in the virtual arrangement, one can particularly easily and reliably check whether the machine component will collide with a unit projecting from above, for example an air duct. Moreover, the method permits to quickly and reliably inspect changes in the planning.

The method may at least partially be carried out at the manufacturer's site and/or at least partially at a plant operator's site. The manufacturer may at least partially manufacture the at least one machine component and/or the plant. The plant operator may manufacture or process a product with the at least one machine component and/or the plant, and/or fill the product into tanks, barrels and/or containers. For example, the method may be carried out by the manufacturer during an offer process to inspect the arrangement of the at least one machine component of an offer in the real surroundings of the plant operator. For example, the configuration of the at least one machine component may be accomplished based on the task specifications and the generation of the at least one associated virtual 3D-machine measurement sheet at the manufacturer's site, and the capturing of the real surroundings and the arrangement of the at least one virtual 3D-machine measurement sheet may be accomplished in the captured real surroundings at the plant operator's site.

The at least one machine component may comprise one or several treatment machines for containers, for example a container manufacturing machine, a container cleaning machine, an inspection machine, a filling machine, a labeling machine, a pasteuriser, a packaging machine, a depalletizer and a palletizer, a pusher and/or a transporter. Equally, the at least one machine component may comprise a product processing machine and/or a product manufacturing machine, for example a brewhouse, a pasteuriser, and the like.

The containers may be provided for receiving a product, such as beverages, foodstuff, sanitary products, paste, chemical, biological and/or pharmaceutical products. The containers may be plastic bottles, metal cans or glass bottles. The plant in the field of the beverage processing industry may be provided for manufacturing the product, fill the product into the containers, close the containers, label the containers and/or pack the containers into packs.

The method may be provided for planning the arrangement of the at least one machine component in the plant in the field of the beverage processing industry. It is conceivable to plan the complete plant or only part of the plant with said method. For example, there may be machine components already existing in the plant, where with the method, the arrangement of the at least one machine component in addition to the existing machine components is planned. For example, the at least one machine component may comprise at least one existing machine component and at least one additional (new) machine component. However, it is also conceivable that only the at least one additional machine component is configured with the method, and the at least one virtual 3D-machine measurement sheet is generated from the at least one additional configured component, and the at least one existing machine component is considered by capturing the real surroundings.

The task specifications may be, for example, parameters of an offer, of specifications and/or of performance specifications for the plant. The task specifications may be, for example, specifications stating that one or several machine components must be configured as rotary machines. Equally, the task specifications may be a machine component type, a machine output, a container type to be processed, and/or the like.

During configuration, the task specifications may be consulted for determining the exact geometrical design of the at least one machine component. Moreover, the functional design may be determined.

The at least one associated virtual 3D-machine measurement sheet may be a three-dimensional geometrical model of the at least one configured machine component. For example, the geometrical model may be a plurality of triangular and/or quadrangular surface elements which form at least one coherent surface network and which represent the extent of the at least one machine component. Equally, the geometrical model may be CAD data of the at least one configured machine component. It is also conceivable that the at least one associated virtual 3D-machine measurement sheet is a schematic geometrical model representing the essential measures of the at least one machine component as a 3D-model. In the generation of the at least one associated virtual 3D-machine measurement sheet, for example several geometrical modules of one single machine component stored in a database may be combined due to the configuration.

The real surroundings may comprise, for example, a space provided for the plant in the field of the beverage processing industry, a machine hall and/or a building. Moreover, the real surroundings may comprise at least one existing machine component which is to be supplemented by additional machine components in the planning. For example, the real surroundings may comprise a floor on which the at least one machine component is to be installed.

The real surroundings may be captured with the camera system as a video or sequence of camera images. It is also conceivable that the real surroundings are captured with the camera system as a 3D-scene. For example, a position of the camera system with respect to the real surroundings may be determined in the method to arrange the at least one virtual 3D-machine measurement sheet, independent of a movement of the camera system, at the same position in the real surroundings. Moreover, with the method, the floor may be detected as an area to arrange the at least one virtual 3D-machine measurement sheet thereon.

The statement that “the at least one virtual 3D-machine measurement sheet is virtually arranged in the captured real surroundings” can mean herein that at least one configured geometrical model of the at least one machine component is virtually arranged in the captured real surroundings based on at least one position specification. For example, the virtual arrangement of an operator may be shown on a monitor, data goggles, or the like. For example, the virtual arrangement may comprise a perspective projection of the virtual 3D-machine measurement sheet into the captured real surroundings.

The manufacturer may configure several ones of the machine components and store the associated virtual 3D-machine measurement sheets as alternative machine variations in a database for the plant operator, wherein the associated virtual 3D-machine measurement sheets are transmitted from the database via a network data connection to the plant operator and are optionally virtually arranged in the captured real surroundings. This permits to suggest the alternative machine variations to the plant operator as the customer so he can quickly and reliably inspect their arrangements in the real surroundings. A network data connection is to be understood as all transmission paths for digital data, be it a data line, an Internet connection or the communication path via mobile intermediate storages, such as external hard disks or USB memories.

It is also conceivable that the manufacturer configures several alternative plants with the machine components and correspondingly stores several virtual plant variations with the respective associated virtual 3D-machine measurement sheets for the plant operator in a database, wherein the virtual plant variations with the respective associated virtual 3D-machine measurement sheets are transmitted from the database via a network data connection to the plant operator and optionally virtually arranged in the captured real surroundings. Thereby, complete plant variations may be stored as blocks in the database to inspect their arrangement in the real surroundings quickly and reliably. For example, plant variations with linear or rotary machines may be offered and checked as alternatives.

It is moreover conceivable to generate the at least one virtual 3D-machine measurement sheet on a mobile computer and store the at least one 3D-machine measurement sheet in a database on the mobile computer, wherein the at least one associated virtual 3D-machine measurement sheet is retrieved from the database on the mobile computer and virtually arranged in the captured real surroundings. Thereby, the configuration may be carried out at the plant operator's site, and the configuration may be virtually arranged as the result in the real surroundings directly afterwards, for example. The database may comprise, for example, one or several files in a storage medium of the mobile computer to store the at least one associated virtual 3D-machine measurement sheet.

The at least one machine component and/or the at least one virtual 3D-machine measurement sheet may be stored in a database. With the database, a particularly easy access to the at least one machine component and/or the at least one virtual 3D-machine measurement sheet by the manufacturer and the plant operator is possible. Thereby, the method may be carried out quickly and uncomplicatedly. It is also conceivable that the at least one virtual 3D-machine measurement sheet is read out from the database by the manufacturer and transmitted to the plant operator via the network data connection. The network data connection can be, for example, an Internet connection. The at least one 3D-machine measurement sheet may be transmitted from the database by means of an e-mail or the like, for example. It is also conceivable that the plant operator receives, in an e-mail, a link to the at least one virtual 3D-machine measurement sheet in the database and then directly downloads the same. However, it is also conceivable that the plant operator directly accesses the database from a software, an application, or by means of instructions to be carried out by a computer via the network data connection.

The capturing of the real surroundings and the virtual arrangement of the at least one virtual 3D-machine measurement sheet in the captured real surroundings may be accomplished by means of a mobile computer, such as with a laptop computer, a tablet computer, data goggles, or with a smartphone. Thereby, the plant operator as the customer may particularly easily generate and check the arrangement with existing hardware. It is conceivable that the plant operator to this end installs software or an application provided by the manufacturer on the mobile computer to carry out the procedure steps for capturing the real surroundings and to virtually arrange the at least one virtual 3D-machine measurement sheet in the real surroundings.

It is conceivable that the camera system is integrated in the mobile computer. Thereby, no special hardware for the camera system has to be procured. For example, the camera system may be a camera of the mobile computer, for example the camera of a tablet computer.

In one or more examples, the camera system may comprise a camera with a CCD- or CMOS image sensor and a lens. Furthermore, the camera system may comprise a data connection to the mobile computer to transmit captured image data.

The virtual 3D-machine measurement sheets may be, in the course of the arrangement, shifted and/or rotated with respect to the real surroundings to run through different machine arrangements for installation variations. This permits to simply and reliably compare the different machine arrangements with each other on site in the real surroundings. “Shifting” can mean herein that the positions of the virtual 3D-machine measurement sheets are changed with respect to the real surroundings.

The virtual arrangement of the at least one virtual 3D-machine measurement sheet may be checked in the real surroundings for a collision with at least one other object. This ensures that no machine parts overlap which would then result in cumbersome changes of the planned arrangement during installation. The at least one other object may be an object represented by another virtual 3D-machine measurement sheet, an object in the real surroundings (for example a wall, supply shafts and the like) and/or an object in the captured real surroundings. For example, in the collision check, an overlap of the at least one virtual 3D-machine measurement sheet with the object of the real surroundings may be determined.

The real surroundings may be captured as at least one camera image, wherein the at least one virtual 3D-machine measurement sheet is perspectively arranged with respect to the at least one camera image. By the perspective arrangement in the at least one camera image, the machine configuration may be reproduced such that the operator obtains a particularly realistic impression. In other words, the perspective arrangement of the virtual 3D-machine measurement sheet may be the same image perspective as that of the captured real surroundings.

Moreover, the present disclosure provides at least one storage medium readable by the computer system, a computer for planning a plant in the field of the beverage processing industry, and a mobile computer for planning a plant in the field of the beverage processing industry.

By the readable instructions instructing the computer at the manufacturer's site to configure the plant in the field of the beverage processing industry with several machine components based on the task specifications, the machine types and/or a special arrangement of machine parts are considered in the planning. By generating the at least one associated virtual 3D-machine measurement sheet from the at least one configured machine component, the extent of the respective machine component can be considered not only as a 2D-projection, but as a 3D-body. Moreover, respective different cross-sections of the at least one machine component in different heights may be thereby considered in planning. Subsequently, the virtual 3D-machine measurement sheets are provided as alternative machine variations in the database for the plant operator.

Since the instructions to be carried out instruct the mobile computer at the plant operator's site to capture the real surroundings for the installation of the at least one machine component with the camera system, the actual premises for the plant are captured, instead of a possibly only incomplete or faulty plan. Therefore, differences between the actual premises and the planning are avoided. Moreover, the mobile computer is instructed to the virtual 3D-machine measurement sheets from the database via the network data connection to the mobile computer. Thereby, the virtual 3D-machine measurement sheets are transmitted from the computer at the manufacturer's site to the mobile computer at the plant operator's site in a simple manner and are available there. Since the at least one virtual 3D-machine measurement sheet is virtually arranged in the real surroundings, an operator may particularly reliably and quickly see whether the at least one machine component may be erected unobstructedly. For example, in the virtual arrangement, it can be particularly easily and reliably checked whether the machine component will collide with a unit projecting from above, for example an air duct. Moreover, the method permits to quickly and reliably check changes in the planning.

Moreover, the present disclosure provides a mobile computer for planning a plant in the field of the beverage processing industry. By the configuration of the at least one machine component, the generation and the arrangement of the at least one associated virtual 3D-machine measurement sheet being accomplished in the real surroundings on the mobile computer, the plant may be configured on site and the result may be shown in the real surroundings directly afterwards.

The instructions readable by the computer system, the computer and/or the mobile computer may be a computer program, an application and/or software.

The computer, where the computer may be a stationary computer, may be arranged at the site of the manufacturer of the plant in the field of the beverage processing industry. The computer may be a personal computer, a laptop or the like. On the other hand, the mobile computer may be arranged at the plant operator's site or be made available to the latter. The mobile computer may be a laptop, a tablet computer, data goggles, or a smartphone.

The network data connection may be a computer network which may utilize part of the Internet. For example, the network data connection may be established by means of permanently laid network cables and/or via a radio data connection (WLAN, Bluetooth and/or a mobile data network). As an alternative, the 3D-models may also be made available via mobile intermediate storages, such as external hard disks or USB memories.

The storage medium may be a hard disk, a mobile memory stick (e.g. USB flash drive), a CD, a DVD, a Blueray disk, a memory chip and/or a storage module.

The computer system, computer, stationary computer and/or mobile computer may herein mean one unit each comprising a CPU, a storage medium, a data bus and/or an interface to the network data connection. For example, the units may each comprise a monitor, an input unit, for example a keyboard and/or a touch screen.

Moreover, the at least one storage medium readable by the computer system, the stationary computer and/or the mobile computer may be embodied to carry out the above-described procedure steps individually or in any combination.

Further features and advantages of the present disclosure will be illustrated below more in detail with reference to the embodiments represented in the figures.

### BRIEF DESCRIPTION OF THE FIGURES

FIG. 1 shows an exemplified embodiment of a method according to the present disclosure for planning a plant in the field of the beverage processing industry as a flowchart.

FIG. 2 shows an exemplified embodiment of a stationary computer according to the present disclosure at the site of the manufacturer of the plant in the field of the beverage processing industry for carrying out partial steps of the method of FIG. 1 in a perspective representation.

FIG. 3 shows an exemplified embodiment of a mobile computer according to the present disclosure at the plant operator's site for carrying out partial steps of the method of FIG. 1 in a perspective representation.

FIG. 4 shows a detailed view of the mobile computer of FIG. 3 in a front view.

### DETAILED DESCRIPTION

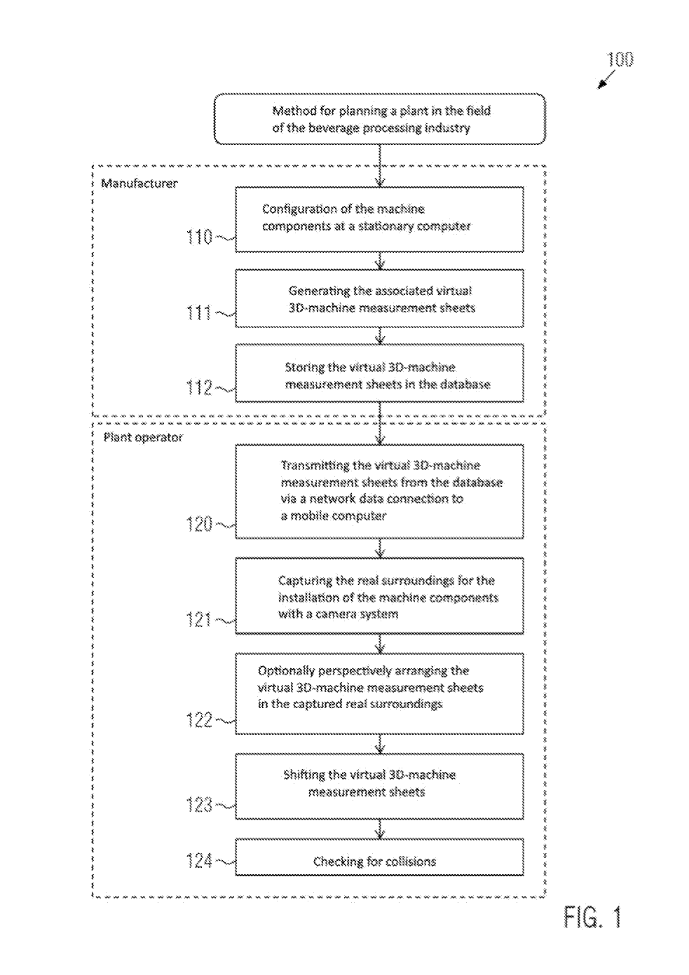

FIG. 1 depicts an exemplified embodiment of the method 100 according to the present disclosure for planning a plant in the field of the beverage processing industry as a flowchart. In the method 100, steps 110, 111, and 112 are carried out at the site of the manufacturer of the plant (or the at least one machine component), and steps 120, 121, 122, 123, and 124 are carried out at the plant operator' site.

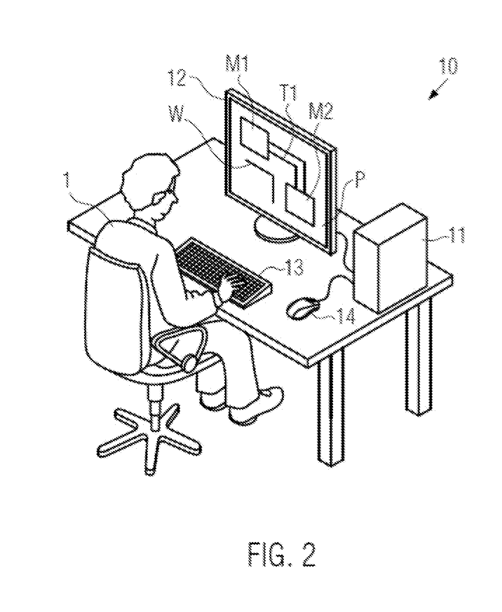

At the site of the manufacturer of the plant, a stationary computer with software with machine-readable instructions is set up for carrying out the steps 110, 111,112 (cf. FIG. 2).

In step 110, the machine components are being configured on the stationary computer based on task specifications. The task specifications comprise, for example, the machine type of the respective machine component, the container types to be processed therewith, the products to be filled into the containers, the machine output, etc. Subsequently, an operator, for example a product specialist, configures the individual machine components and determines their exact geometry thereby. For example, the computer upon which the machine components are being configured may receive inputs from the operator in order to configure the individual machine components and determine the exact geometry of the configured machine components.

In step 111, the associated virtual 3D-machine measurement sheets are generated from the configured machine components. Since, among other things, the geometry of the respective machine components are determined with the configuration, now a corresponding geometrical model may be generated for each virtual 3D-machine measurement sheet. Moreover, the 3D-machine measurement sheet may comprise further information about the configured machine components, for example the machine type, the machine output, and the like. The geometrical model may comprise triangular and/or quadrangular surface elements forming at least one coherent surface network as a representation of the associated machine component. Moreover, the 3D-machine measurement sheet may comprise geometrical dimensional specifications.

In subsequent step 112, the virtual 3D-machine measurement sheets are stored in a database. The database may be implemented, for example, on a server computer which can be accessed via a network data connection. For example, the network data connection may also be accessible via the Internet so that the plant operator may access the virtual 3D-machine measurement sheets in the database.

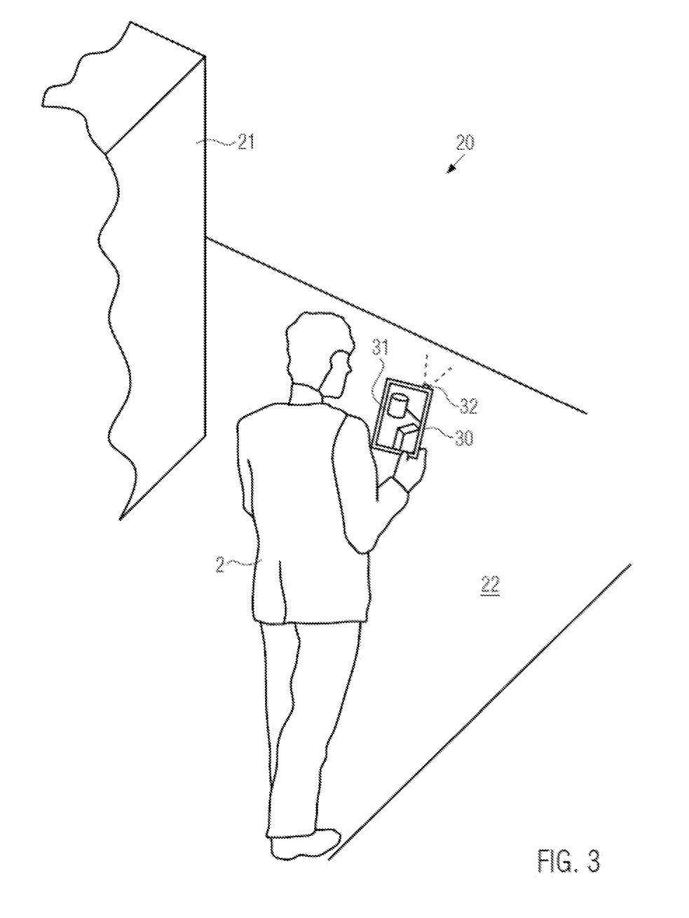

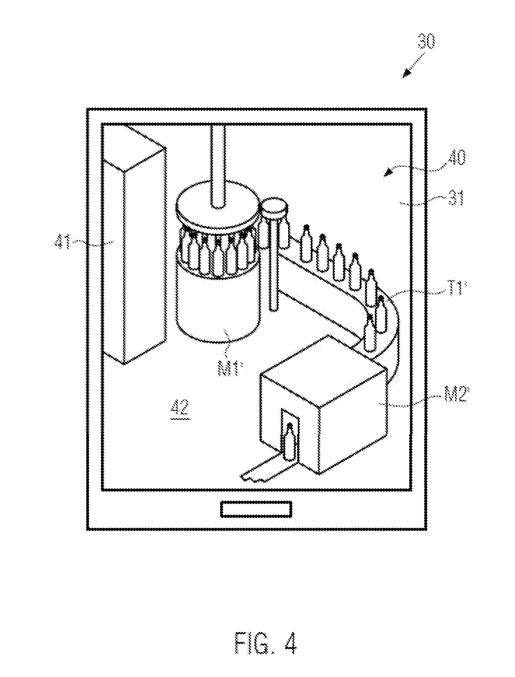

At the plant operator's site, an application with machine-readable instructions is installed on a mobile computer to carry out procedure steps 120, 121, 122, 123, 124 (cf. FIGS. 3-4). The mobile computer may be, for example, a tablet computer.

The plant in the field of the beverage processing industry may be, for example, a plant for filling a beverage into containers, such as bottles.

Initially, in step 120, the virtual 3D-machine measurement sheets may be transmitted from the database via the network data connection and received at the mobile computer. For example, the manufacturer may send an e-mail to the plant operator with a link to the database to this end. It is also conceivable that the manufacturer reads out the virtual 3D-machine measurement sheets as a file from the database and sends the virtual 3D-machine measurement sheets to the plant operator as an e-mail to this end.

Subsequently, in step 121, the real surroundings for installing the machine components are captured with a camera system of the mobile computer. For example, the real surroundings are a machine hall in which the plant is to be installed later. In the process, the mobile computer may be held by an operator such that the camera system captures the real surroundings. For example, the part of the real surroundings that is provided for the installation of the machine components may be captured with the camera system.

The capturing of the real surroundings is here accomplished as image data and may be continued during subsequent step 122, optionally during steps 123, 124, so that the image data may be consistent with the movement of the mobile computer.

In step 122, the virtual 3D-machine measurement sheets may then be optionally arranged perspectively in the captured real surroundings. For example, the arranging at step 122 may be carried out responsive to receiving a user input at the computer at the plant operator's site. To this end, the image data of the camera system may be evaluated with respect to the image perspective and the position of the camera system by means of image processing. By a calibration of the imaging properties of the camera system, it is possible to determine the magnification, thereby considering, in the virtual arrangement, and the proportions in size in the captured real surroundings.

Moreover, due to the configuration of the machine components and/or due to specifications by the operator at the plant operator's site, the positions of the respective machine components may be defined in the real surroundings. Correspondingly, the 3D-machine measurement sheets may then be perspectively arranged in the captured real surroundings so that they appear superimposed on a monitor of the mobile computer with the captured real surroundings at the position. In other words, the virtual 3D-machine measurement sheets are shown in the captured real surroundings as if they were already installed therein. Moreover, the operator may optionally arrange individual virtual 3D-machine measurement sheets, for example to evaluate alternative machine variations.

In the optional step 123, the operator may then shift the virtual 3D-machine measurement sheets in the captured real surroundings, for example to check an alternative position of a machine component.

In a further optional step 124, it is then determined whether there are any collisions. Here, collisions of the virtual 3D-machine measurement sheets (and thereby the machine components) both with each other and with objects in the real surroundings may be checked. When checking the virtual 3D-machine measurement sheets, overlaps of the geometrical models are calculated. Vice-versa, the operator may detect a collision of a virtual 3D-machine measurement sheet with an object in the real surroundings visually on the monitor.

Since in the virtual 3D-machine measurement sheets, the extent of the configured machine components is stored in all three directions in space, very complex geometrical conditions of the configured machine components may be quickly and safely arranged and checked at the plant operator's site in the captured real surroundings. Moreover, machine variations may be particularly easily arranged alternatively, and their advantages or disadvantages in their later installation may be evaluated.

It is also conceivable that in the method 100, the manufacturer configures several alternative plants with the machine components and correspondingly stores several virtual plant variations with the respective associated virtual 3D-machine measurement sheets for the plant operator in the database, and that the virtual plant variations are transmitted, with the respective associated virtual 3D-machine measurement sheets, from the database via a network data connection to the plant operator, and are optionally virtually arranged in the captured real surroundings. Thereby, the operator may particularly quickly and safely check the installations of the various plant variations.

FIG. 2 depicts, in a perspective representation, an exemplified embodiment of a stationary computer 10 according to the present disclosure at the site of the manufacturer of the plant in the field of the beverage processing industry for carrying out the partial steps 110, 111, 112 of the method 100 of FIG. 1.

The operator 1 who is carrying out steps 110, 111, 112 of the above-described method 100, at a desk with the computer 10, for planning the plant in the field of the beverage processing industry is shown. The computer 10 is here, for example, a stationary one and comprises a PC (Personal Computer) 11, a monitor 12, a keyboard 13, and a computer mouse 14. The stationary computer 10 is embodied with a storage medium in which instructions readable by the stationary computer 10 are stored as software which, if carried out, instruct the stationary computer 10 to carry out steps 110, 111, 112. It is conceivable that a laptop computer is employed as an alternative.

On the monitor 12, one can see, merely by way of example, the machine components M1, T1, and M2 which are arranged in the plan P. The machine component M1 is, for example, a filling machine for filling a beverage into containers. The machine component T1 is, for example, a transporter for transporting the containers with the beverage filled therein to the following machine component M2 which is embodied here, for example, as a labeling machine.

In the configuration of the machine components M1, T1, M2 according to step 110, the operator 1 selects, among other things, that the filling machine M1 is a filling machine for plastic bottles to be configured as rotary machines. For the transporter T1, the operator 1 selects, among other things, that T1 is a linear transporter which transports the containers around a 90° curve due to a wall W. Moreover, the operator 1 selects, among other things, that the labeling machine M2 is intended to process sleeve labels. Moreover, different machine dimensions for different processing speeds, container diameters or volumes may be imaged.

Subsequently, the software automatically generates, from the configured machine components M1, T1, M2, the associated virtual 3D-machine measurement sheets according to step 111 as data records and stores the associated virtual 3D-machine measurement sheets in a database not depicted here in greater detail according to step 112.

FIG. 3 depicts an exemplified embodiment of a mobile computer 30 according to the present disclosure at the plant operator's site for carrying out the partial steps 120, 121, 122, 123, and 124 of the method 100 of FIG. 1 in a perspective representation. Furthermore, in FIG. 4, a detailed view of the mobile computer of FIG. 3 is depicted in a front view. On the mobile computer 30, an application for carrying out the steps 120-124 is installed.

One can see in FIG. 3 the real surroundings 20, for example an essentially empty machine hall with the floor 22. Moreover, the wall 21 can be seen which can also be seen in FIG. 2 merely schematically in the plan P on the monitor 12 as a Wall W.

An operator 2 is holding a mobile computer 30, for example a tablet computer, in front of him at the plant operator's site. The tablet computer comprises a monitor 31 configured as a touch screen and a camera system 32. Moreover, the mobile computer 30 comprises an interface, such as a WLAN interface, and/or a mobile communication data interface as part of a network data connection via which the virtual 3D-machine measurement sheets are transmitted from the database to the mobile computer 30 (step 120).

Moreover, one can see that the operator 2 is holding the mobile computer 30 in his hands such that the camera system 32 captures the real surroundings 20 and these are represented on the monitor 31 as an image (step 121). Moreover, at the monitor 31, the virtual 3D-machine measurement sheets are optionally perspectively arranged in the captured real surroundings (step 122).

The representation on the monitor 31 is shown more in detail in FIG. 4. One can see there that at the monitor 31, the captured real surroundings 40 with the floor 42 and the wall 41 are shown as an image. Moreover, in the captured real surroundings 40, the 3D-machine measurement sheets M1′, T1′, and M2′ are virtually arranged. Thereby, the operator 2 gets an impression of how the machine components M1, T1, and M2 will be arranged in the captured real surroundings 40 after their installation. Moreover, the operator 2 may quickly and safely check whether, for example, the 3D-machine measurement sheet M1′ (filling machine) overlaps the wall 41. Thereby, collisions may be avoided (cf. step 124). Moreover, the operator 2 may shift all 3D-machine measurement sheets M1′, T1′, and M2′ on the monitor 31 individually, in groups or as a whole to arrange the 3D-machine measurement sheets differently.

By the software instructing the stationary computer 10 at the manufacturer's site to configure the plant with several machine components M1, T1, M2 based on the task specifications, the machine types and/or a special arrangement of machine parts are taken into consideration during the planning. By the associated virtual 3D-machine measurement sheets M1′, T1′, M2′ being generated from the configured machine components M1, T1, M2, the extent of the respective machine component M1, T1, M2 may be considered not only as 2D-projection, but also as a 3D-body. Moreover, respective different cross-sections of the machine components M1, T1, M2 in different heights may be thereby considered during planning. Subsequently, the virtual 3D-machine measurement sheets M1′, T1′, M2′ are made available to the plant operator in the database.

Since the instructions of the application to be carried out instruct the mobile computer 30 at the plant operator's site to capture the real surroundings 20 for the installation of the machine components M1, T1, M2 with the camera system 32, the actual premises for the plant are captured, instead of a possibly only incomplete or faulty plan. Therefore, differences between the actual premises and the planning are avoided. Moreover, the mobile computer 30 is instructed to transmit the virtual 3D-machine measurement sheets M1′, T1′, M2′ from the database via the network data connection to the mobile computer 30. Thereby, the virtual 3D-machine measurement sheets M1′, T1′, M2′ are transmitted from the stationary computer 10 at the manufacturer's site to the mobile computer 30 at the plant operator's site in a simple manner and are available there. Since the virtual 3D-machine measurement sheets M1′, T1′, M2′ are virtually arranged in the captured real surroundings 40, an operator 2 can particularly reliably and quickly see whether the machine components M1, T1, M2 can be unobstructedly erected. For example, in the virtual arrangement, it may be particularly easily and reliably checked whether the machine components M1 collide with the wall W. Moreover, it is possible to quickly and reliably check changes in the planning.

It is also conceivable that the configuration of the machine components M1, T1, M2, the generation and the arrangement of the associated virtual 3D-machine measurement sheets M1′, T1′, M2′ in the captured real surroundings 40 are accomplished only on the mobile computer 30. The associated virtual 3D-machine measurement sheets M1′, T1′, M2′ may be stored in a database on the mobile computer 30 and retrieved again. Thereby, the plant may be configured on site on the mobile computer 30, and indicated directly afterwards as the result in the captured real surroundings 40.

It will be understood that features mentioned in the above described exemplified embodiments are not restricted to this combination of features and are also possible individually or in any other combinations.

1. A method for planning a plant in a field of a beverage processing industry with at least one machine component, wherein the at least one machine component is configured based on task specifications, comprising:
generating at least one associated virtual 3D-machine measurement sheet from the at least one configured machine component;
capturing real surroundings for the installation of the at least one machine component with a camera system; and
arranging the at least one virtual 3D-machine measurement sheet virtually in the captured real surroundings.

2. The method according to claim 1, wherein there are a plurality of machine components, and wherein a manufacturer configures several of the plurality of the machine components and stores the associated virtual 3D-machine measurement sheets for a plant operator as alternative machine variations in a database, and wherein the associated virtual 3D-machine measurement sheets are transmitted from the database via a network data connection to the plant operator and are optionally virtually arranged in the captured real surroundings.

3. The method according to claim 1, wherein a manufacturer configures several alternative plants with the at least one machine component and correspondingly stores several virtual plant variations with respective associated virtual 3D-machine measurement sheets for a plant operator in a database, and wherein the virtual plant variations are transmitted, with the respective associated virtual 3D-machine measurement sheets, from the database via a network data connection to the plant operator and are optionally virtually arranged in the captured real surroundings.

4. The method according to claim 1, wherein the at least one virtual 3D-machine measurement sheet is generated on a mobile computer and stored in a database on the mobile computer, and wherein on the mobile computer, the at least one associated virtual 3D-machine measurement sheet is retrieved from the database and virtually arranged in the captured real surroundings.

5. The method according to claim 1, wherein the at least one machine component and/or the at least one virtual 3D-machine measurement sheet is stored in a database.

6. The method according to claim 1, wherein the capturing of the real surroundings and the virtual arrangement of the at least one virtual 3D-machine measurement sheet are accomplished in the captured real surroundings by means of a mobile computer, preferably with a laptop computer, a tablet computer, data goggles, or with a smartphone.

7. The method according to claim 6, wherein the camera system is integrated in the mobile computer.

8. The method according to claim 1, wherein the virtual 3D-machine measurement sheets are shifted and/or rotated during the arranging with respect to the captured real surroundings to run through different machine arrangements for installation variations.

9. The method according to claim 1, wherein the virtual arrangement of the at least one virtual 3D-machine measurement sheet is checked in the captured real surroundings for a collision with at least one other object.

10. The method according to claim 1, wherein the real surroundings are captured as at least one camera image, and wherein the at least one virtual 3D-machine measurement sheet is perspectively arranged with respect to the at least one camera image.

11. A computer system, the computer system comprising:
at least one storage medium readable by the computer system, the at least one storage medium comprising instructions readable by the computer system and which, are executable by the computer system to instruct the computer system to:
generate at least one associated virtual 3D-machine measurement sheet from at least one configured machine component,
capture real surroundings for an installation of the at least one machine component with a camera system, and
arrange the at least one virtual 3D-machine measurement sheet virtually in the captured real surroundings, and
wherein the computer system comprises at least one stationary computer and a mobile computer which are interconnected via a network data connection.

12. A computer for planning a plant in a field of a beverage processing industry, comprising:
a storage medium readable by the computer, the storage medium comprising instructions readable by the computer which are executable by the computer to:
instruct the computer to configure, at a manufacturer's site, a plant in the field of the beverage processing industry with several machine components based on task specifications, and to generate associated virtual 3D-machine measurement sheets from the task specifications, wherein the virtual 3D-machine measurement sheets are stored as alternative machine variations in a database for a plant operator.

13. The computer of claim 12, wherein the computer is a stationary computer.

14. A mobile computer for planning a plant in a field of a beverage processing industry, comprising:
a storage medium readable by the mobile computer), the storage medium comprising instructions readable by the mobile computer which are executable by the mobile computer to:
instruct the mobile computer to capture, at a plant operator's site, real surroundings for installing machine components with a camera system, wherein virtual 3D-machine measurement sheets associated with the machine components are transmitted from a database via a network data connection to the mobile computer.

15. The mobile computer according to claim 14, wherein the mobile computer is a laptop computer, a tablet computer, data goggles, or a smart phone.

16. The mobile computer according to claim 14, wherein the virtual 3D-machine measurement sheets are virtually arranged in the captured real surroundings.

17. A mobile computer for planning a plant in a field of a beverage processing industry, comprising:
a storage medium readable by the mobile computer, the storage medium comprising instructions readable by the mobile computer which are executable by the mobile computer to:
instruct the mobile computer to configure the plant in the field of the beverage processing industry with at least one machine component based on task specifications, and
generate from the task specifications at least one associated virtual 3D-machine measurement sheet, wherein the at least one virtual 3D-machine measurement sheet is stored in a database on the mobile computer, wherein real surroundings for the installation of the at least one machine component are captured with a camera system, wherein the at least one virtual 3D-machine measurement sheet is read out from the database on the mobile computer, and wherein the virtual 3D-machine measurement sheet is virtually arranged in the captured real surroundings.

18. The mobile computer of claim 17, wherein the mobile computer is a laptop computer, a tablet computer, data goggles, or a smartphone.
